(19) United States
(12) Patent Application Publication
(10) Pub. No.: US 2026/0211630 A1
(43) Pub. Date: Jul. 23, 2026

(54) NON-TRANSITORY STORAGE MEDIUM STORING MODULE PACKAGE THEREON, MODULE PACKAGE GENERATING DEVICE, AND MODULE PACKAGE GENERATING METHOD

(71) Applicant: Taisuke Katsumoto, Sunto Shizuoka (JP)

(72) Inventor: Taisuke Katsumoto, Sunto Shizuoka (JP)

(73) Assignee: ETRIA CO., LTD., Kanagawa (JP)

(21) Appl. No.: 19/281,634

(22) Filed: Jul. 26, 2025

(30) Foreign Application Priority Data
Jan. 20, 2025 (JP) 2025-007755

(51) Int. Cl. G06F 8/30

(52) U.S. Cl. CPC G06F 8/30

(57) ABSTRACT

A module package according to an embodiment is a module package that includes: a first type module that is common to target models of image forming devices and are identical among the target models; a second type module that is unique to the respective target models; restoration data used for restoring a third type module that is common to the target models and are not identical among the target models for each of the target models; and a restoration tool used for restoring the third type module on the basis of the restoration data.

### CROSS-REFERENCE TO RELATED APPLICATION

This application is based upon and claims the benefit of priority from Japanese Patent Application No. 2025-007755, filed January 20, 2025, the entire content of which is incorporated herein by reference.

### FIELD

An embodiment described herein relates to a module package, a module package generating device, and a module package generating method.

### BACKGROUND

Manufacturers of image forming devices may offer multiple models with some software modules configured to be common as a product series. In a case in which software modules are supplied to target models of such a product series, the software modules may be supplied in the form of a module package in which software modules required for each model are combined. Regarding such a module package, conventionally, target software modules may be packaged by being divided into software modules that are common to target models and software modules that are not common thereto.

In generation of a module package corresponding to all the target models, conventionally, a person in charge of product design determines a module type (common or non-common) on the basis of hash values and the like and manually manages the information, for example, using a CSV file and the like. However, in such a management method, there is a likelihood of occurrence of a problem that a module package is not correctly generated due to error in judgment of a person in charge, an editing error in a CSV file, and the like, and modules are not correctly installed in an image forming device of a target model. For example, there are cases in which hash values of substantially common modules may be different from each other due to differences (for example, a date and a path) in compile environments and the like. For such modules, although a person in charge determines each module to be common or non-common on the basis of his or her judgment (for example, a large-size module is classified into a common module or the like), there is a likelihood that a judgment result is not correctly reflected on a CSV file due to manual editing error, and a module package is not properly generated.

### BRIEF DESCRIPTION OF THE DRAWINGS

FIG. 1 is a diagram illustrating an example of a system configuration of a module management system 1 according to an embodiment.

FIG. 2 is an external view illustrating an example of a configuration of an image forming device 100 according to an embodiment.

FIG. 3 is a block diagram illustrating an example of a hardware configuration of an image forming device 100 according to an embodiment.

FIG. 4 is a diagram illustrating an example of a functional configuration of a controller 170 of the image forming device 100 according to the embodiment.

FIG. 5 is a block diagram illustrating an example of a hardware configuration of an administrator terminal 300 according to an embodiment.

FIG. 6 is a diagram illustrating an example of a functional configuration of a controller 360 of the administrator terminal 300 according to the embodiment.

FIG. 7 is a diagram illustrating a specific example of module types of target modules according to an embodiment.

FIG. 8 is a diagram illustrating a configuration example of an integrated package according to an embodiment.

FIG. 9 is a flowchart illustrating an example of a flow of a process in which the administrator terminal 300 according to the embodiment generates an integrated package applied to an image forming device 100 of a target model.

FIG. 10 is an image diagram schematically illustrating a process in which the administrator terminal 300 according to the embodiment recognizes a module type by comparing module lists.

### DETAILED DESCRIPTION

A module package according to an embodiment includes a first type module that is common to target models of image forming devices and is identical between the target models described above, a second type module that is unique for each of the target models described above, restoration data used for restoring a third type module that is common to the target models described above and is not identical between the target models for each target model, and a restoration tool used for restoring the third type module described above on the basis of the restoration data described above.

A module package according to an embodiment enables generation of a module package corresponding to a target model with higher accuracy.

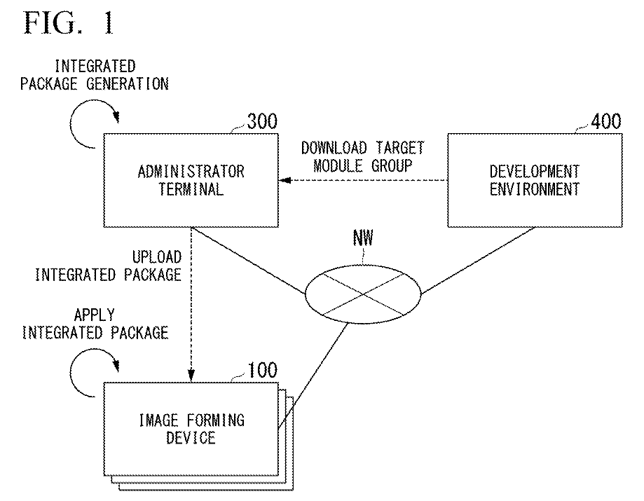

Hereinafter, an embodiment will be described with reference to the drawings. As used throughout this disclosure, the singular forms "a," "an," and "the" include plural references unless the context clearly dictates otherwise. FIG. 1 is a diagram illustrating an example of the system configuration of a module management system 1 according to an embodiment. The module management system 1 manages the distribution and application of software modules (hereinafter, simply referred to as modules) for image forming devices of a plurality of models (hereinafter, referred to as “target models”) to which at least basic software is common. The basic software, for example, is a module that configures an operating system, a BIOS, firmware, and a root file system.

The module management system 1, for example, includes one or more image forming devices 100 corresponding to a target model, an administrator terminal 300, and a development environment 400. The image forming device 100, the administrator terminal 300, and the development environment 400 are able to communicate with each other through a network NW. The network NW may be either a network using radio communication or a network using wired communication. The network NW may be configured by combining multiple networks.

The administrator terminal 300 is used by an administrator of the image forming device 100. The administrator terminal 300, for example, may have a communication function of a personal computer (PC), a smartphone, a tablet, or the like. The administrator generates a module package (hereinafter referred to as an “integrated package”) acquired by combining modules dedicatedly used for a target model (hereinafter, referred to as “target modules”) as one by using the administrator terminal 300. The integrated package may include a module that is unique to each model in addition to modules that are common to the target model. The administrator terminal 300 can supply the generated integrated package to the image forming device 100 of a target model.

The development environment 400 is a system that supports the development and management of target modules. For example, the development environment 400 supplies target modules to the administrator terminal 300 in response to a request from the administrator terminal 300 together with managing target modules for each model. The development environment 400 may be configured using either a single device or multiple devices.

The image forming device 100 can extract modules corresponding to a model of its own device from an integrated package supplied from the administrator terminal 300 and install the modules in its own device. Hereinafter, extraction of modules corresponding to a model of the image forming device 100 from an integrated package and installation of the extracted modules in this image forming device 100 are expressed together as an “application” of the integrated package. The application of an integrated package may be performed for the purpose of manufacturing a product in the manufacturing phase of the image forming device 100 or may be performed for the purpose of servicing and maintenance of a product in the operating phase of the image forming device 100.

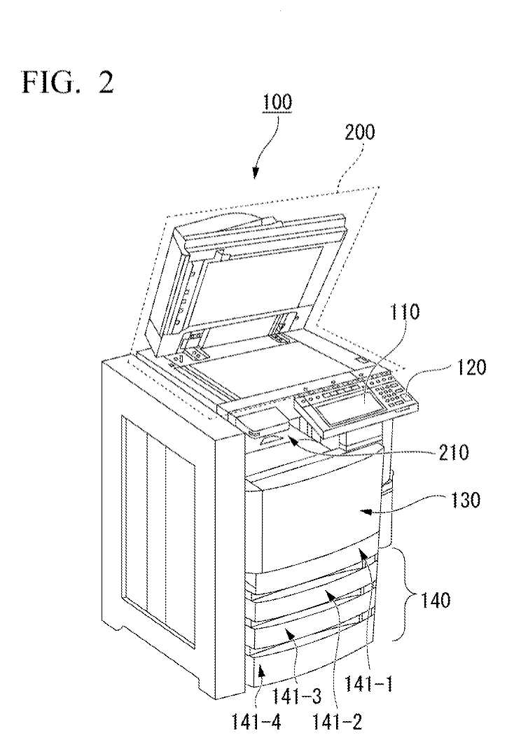

FIG. 2 illustrates an example of a configuration of an image forming device 100 according to an embodiment. The image forming device 100 is, for example, a multifunctional machine. The image forming device 100 includes a display 110, a control panel 120, a formation device 130, a sheet housing device 140, and an image reading device 200. The formation device 130 of the image forming device 100 may be an electrophotographic device that fixes a toner image, an inkjet device, or a device of any other scheme.

The image forming device 100 forms an image on a sheet. The sheet is, for example, paper or label paper. The sheet can be any object as long as the image forming device 100 can form an image on the surface thereof.

The display 110 is an image display device such as a liquid crystal display or an organic electroluminescence (EL) display. The display 110 displays various kinds of information relating to the image forming device 100.

The control panel 120 has multiple buttons. The control panel 120 accepts operations from an administrator. The control panel 120 outputs signals to the processor 153 of the image forming device 100 in response to operations performed by the administrator. The display 110 and the control panel 120 may be configured as an integrated touch panel.

The formation device 130 forms an image on a sheet on the basis of image data included in a job received via a communication line (for example, a network NW) or image data created by the image reading device 200. The formation device 130 forms an image, for example, using processes as below. The formation device 130 forms an electrostatic latent image on a photoconductor drum on the basis of image data. The formation device 130 forms a visible image by attaching a developer to a latent electrostatic image. There are formation devices using toner as a specific example of the developer. The formation device 130 transfers the visible image onto a sheet. The formation device 130 fixes the visible image on the sheet by heating and pressurizing the sheet. The sheet on which the image has been formed is ejected to an ejection area 210. The image formation for a sheet is not limited to the method using toner described above. For example, the image formation for a sheet may be performed using an inkjet scheme.

The sheet housing device 140 houses sheets used for image formation in the formation device 130. The sheet housing device 140 has a paper feeding cassette 141. The sheet housing device 140 of one image forming device 100 may have one paper feeding cassette 141 or may have multiple paper feeding cassettes 141. In this embodiment, the sheet housing device 140 has four paper feeding cassettes 141-1 to 141-4. In the following description, these four paper feeding cassettes are simply referred to as "paper feeding cassette 141" if it is not necessary to distinguish between them.

The image reading device 200 reads image data of a reading target as shades of light. The image reading device 200 records read information as image information. The recorded image information is formed as an image on a sheet by the formation device 130. The recorded image information may be transmitted to another information processing device (for example, the administrator terminal 300) via the network NW.

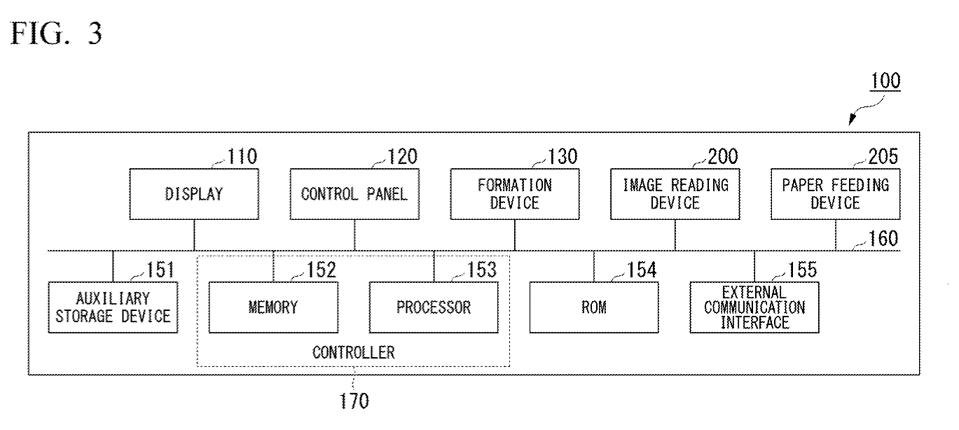

FIG. 3 illustrates an example of the hardware configuration of an image forming device 100 according to an embodiment. The image forming device 100 includes a display 110, a control panel 120, a formation device 130, a paper feeding device 205, an auxiliary storage device 151, a memory 152, a processor 153, a read only memory (ROM) 154, an external communication interface 155, and an image reading device 200. Such devices are connected to be able to perform data communication via a system bus 160. The display 110, the control panel 120, the formation device 130, and the image reading device 200 have been described above and thus, description thereof is omitted here.

The paper feeding device 205 feeds a sheet placed in the paper feeding cassette 141 and an input tray 220 to be described below to the formation device 130. The paper feeding cassette 141 and the input tray 220 are examples of a paper feeder.

Hereinafter, the auxiliary storage device 151, the memory 152, the processor 153, the ROM 154, and the external communication interface 155 are described.

The auxiliary storage device 151 is, for example, a hard disk or a solid-state drive (SSD) and stores various kinds of data. The auxiliary storage device 151 and the memory 152 are examples of a storage. The auxiliary storage device 151 may store, for example, a software program used for controlling the operation of each device included in the image forming device 100.

The memory 152 temporarily stores data used by each device included in the image forming device 100. The memory 152 is, for example, a random-access memory (RAM). The memory 152 may store digital data generated by the image reading device 200. The memory 152 may temporarily store image data that is being printed by the formation device 130.

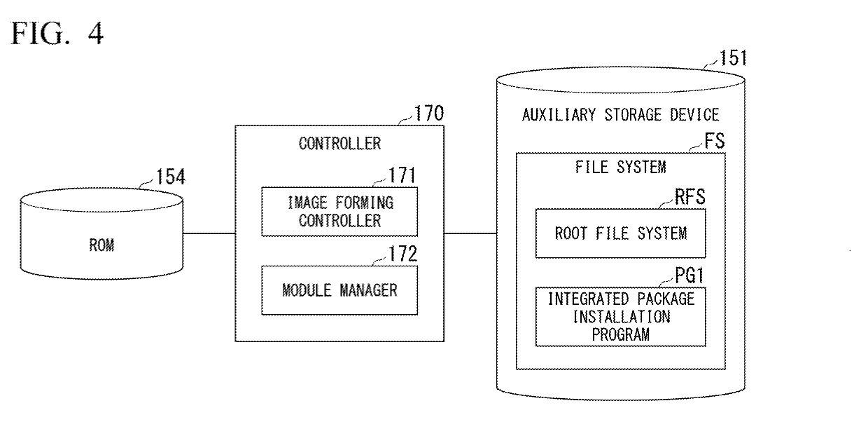

The processor 153 controls the operation of each device included in the image forming device 100. The processor 153 is an example of a controller. The processor 153 loads software programs (modules) stored in the auxiliary storage device 151 or the ROM 154 into the memory 152 and executes the software programs, thereby executing a control process. For example, the processor 153 functions as a controller 170 (see FIG. 4) by executing the software programs described above.

The ROM 154 is an area in which basic software such as an operating system and system firmware required for operating the image forming device 100 is stored. The ROM 154 is a read-only storage device, and it is difficult for information stored therein to disappear even when the power is turned off. Although some ROMs are non-rewritable, the ROM 154 described here is assumed to be a ROM that can be rewritten in accordance with a dedicated operation.

The external communication interface 155 performs data communication with an external device (a device different from the image forming device 100). The external communication interface 155, for example, communicates data with external devices (for example, the administrator terminal 300, the development environment 400, and other devices) via a network NW. For example, other devices such as an external storage device and the like may be configured to be able to be attached/detached to/from the external communication interface 155. The external communication interface 155, for example, may be in compliance with the USB protocol. The external communication interface 155, for example, transmits data in accordance with the control of the processor 153. For example, when data is received, the external communication interface 155 outputs the received data to the processor 153.

FIG. 4 illustrates an example of the functional configuration of the controller 170. The controller 170 includes, for example, an image forming controller 171 and a module manager 172. The image forming controller 171 receives a job from an external information processing device (for example, a PC of a user using the image forming device 100 or the like). Alternatively, the image forming controller 171 may acquire a job from an external storage device in accordance with an operation on the control panel 120. The image forming controller 171 performs control relating to image formation for a sheet on the basis of the image data included in a job. The controls relating to image formation may include control of sheet reading using the image reading device 200, control of sheet conveyance using the paper feeding device 205, and the like in addition to the control of image formation using the formation device 130.

The module manager 172 manages the application of an integrated package to the image forming device 100. The module manager 172 acquires an integrated package from the administrator terminal 300, extracts modules corresponding to its own model from the acquired integrated package, and installs the extracted modules in its own device. The module manager 172 may execute the process of applying an integrated package in a case in which the administrator performs a specific operation on the image forming device 100 or may automatically execute the process of applying the integrated package at a timing designated in advance. The specific operation performed by the administrator may be a direct operation on the image forming device 100 or may be a remote operation through the administrator terminal 300.

For example, the integrated package is uploaded from the administrator terminal 300 to a file system FS of the auxiliary storage device 151 of the image forming device 100. The file system FS includes a root file system RFS and an installer program PG1 of the integrated package. The root file system RFS is an initial file system built at the time of manufacturing the image forming device 100 and is mainly an area in which files necessary for starting up the system are stored. The installer program PG1 is used for executing the process of extracting modules appropriate corresponding to its own model from an integrated package and installing the extracted modules in its own device. An installation destination of the extracted modules may be the file system FS on the auxiliary storage device 151, the ROM 154, or both of them. In a case in which the installation destination is the ROM 154, a writer program dedicated for ROM writing may be included in the installer program PG1. The module manager 172 can apply an integrated package to its own device by executing the installer program PG1.

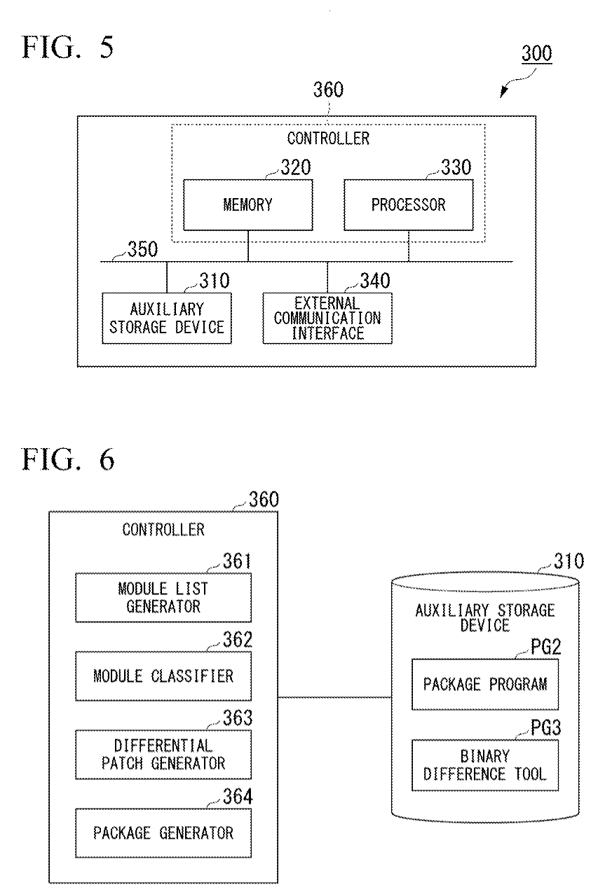

FIG. 5 illustrates an example of the hardware configuration of an administrator terminal 300 according to an embodiment. The administrator terminal 300 includes an auxiliary storage device 310, a memory 320, a processor 330, and an external communication interface 340. Such devices or functional parts perform data communication through a system bus 350.

The auxiliary storage device 310 is, for example, a hard disk or a solid-state drive (SSD) and stores various kinds of data. The auxiliary storage device 310 and the memory 320 are examples of a storage. The auxiliary storage device 310, for example, stores a package program PG2 and a binary difference tool PG3 in advance.

The memory 320 temporarily stores data used by the administrator terminal 300. The memory 320 is, for example, a random-access memory (RAM). The memory 320 may temporarily store the package program PG2, the binary difference tool PG3, and temporary data used thereby.

The processor 330 loads software programs into the memory 320 and executes the software programs, thereby executing a control process for controlling the operation of the administrator terminal 300. For example, the processor 330 functions as the controller 360 by executing the package program PG2 stored in the auxiliary storage device 310.

The external communication interface 340 performs data communication with an external device (a device different from the administrator terminal 300). For example, other devices such as an external storage device and the like may be configured to be able to be attached/detached to/from the external communication interface 340. The external communication interface 340 may perform data communication with other information processing devices (for example, the image forming device 100 and the development environment 400) via a network NW. The external communication interface 340, for example, may be configured in accordance with the USB protocol. The external communication interface 340 transmits data, for example, in accordance with the control of the processor 330. For example, when data is received, the external communication interface 340 outputs the received data to the processor 330.

FIG. 6 illustrates an example of the functional configuration of the controller 360. The controller 360 includes, for example, a module list generator 361, a module classifier 362, a differential patch generator 363, and a package generator 364. The module list generator 361 generates a list of modules (a module list) applied to the image forming device 100 for each target model. For example, in the module list, identification information of each module is written with being associated with unique information of each module. The unique information is used for checking the identity of modules between target models.

In this embodiment, as an example, a case in which the identification information of each module is set as a full path (a combination of a file name and a storage directory path) of the module in the image forming device 100, and a hash value of the module is set as the unique information is described. The unique information may be any information as long as it enables judgment of the identity of a module. The unique information may be any information as long as it enables identification of a module. A hash value is a numerical value with a fixed number of digits calculated from original data using a hash function. Hash values are generated using a hash function such that the values are necessarily the same if the original data is the same, and the probability of hash values conflicting between different data is sufficiently small, and thus the hash values are widely used as a means for verifying the identity of data.

In this embodiment, in the development environment 400, modules for target models are managed for each model in the same directory structure as that of the image forming device 100 that is an application destination. In this case, for example, the module list generator 361 can generate a module list for each target model by downloading modules of target models into download areas for respective models for each directory structure and performing processes (1) to (3) described below for each of the download areas.

(1) Obtain full paths for all the modules stored in the download area.

(2) Obtain a hash value for each module of (1).

(3) Output the full path and the hash value of each module to a file (a module list) in association with each other.

The module classifier 362 classifies target modules into the following first to third module types by comparing module lists between target models.

### First Type Module

Modules that are common and identical among target models.

### Second Type Module

Modules that are unique for each target model.

### Third Type Module

Modules that are common and non-identical among target models.

In this embodiment, modules of which full paths are the same between target models are expressed as “common” modules, and modules of which hash values are the same between the target models are expressed as “identical” modules. Actually, although common or identical modules are assumed in some target models, for the simplification, in this embodiment, a target module is assumed to be classified into one of first to third types.

The differential patch generator 363 generates a differential patch for each module classified into a third type module. The differential patch includes differential data between files before and after update and a program for generating the file after the update by applying this differential data to the file before the update (a difference application program). The differential patch generator 363, for example, may generate a differential patch using a software program (a binary difference tool PG3 in FIG. 6) to which differential data of a binary format such as RTPatch (registered trademark) can be applied. The binary difference tool PG3 may integrally generate the differencing data and the difference application program or may separately generate them. The binary difference tool PG3 is assumed to be stored in the auxiliary storage device 310 in advance.

The package generator 364 combines the first type module, the second type module, and the third type module into one to generate an integrated package. The package generator 364 may generate an integrated package by, first, generating a separate module package for each module type and then combining the module packages for respective module types into one.

The integrated package generated by the package generator 364 is supplied to the image forming device 100 of the target model, and, by executing the installer program PG1 using the image forming device 100, modules corresponding to the model of this image forming device 100 are extracted from the integrated package and are installed in this image forming device 100.

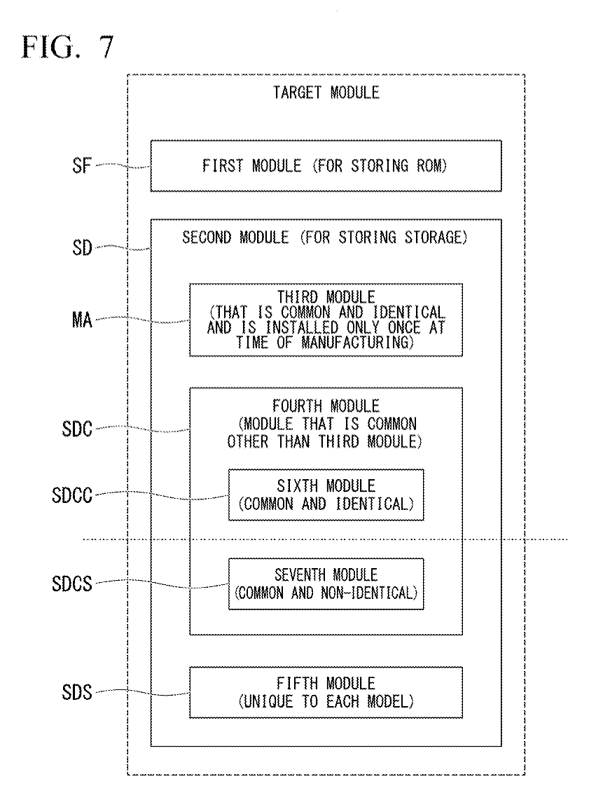

FIG. 7 illustrates a specific example of module types. First, the target modules are broadly classified into a first module SF that is expanded in a ROM area (the ROM 154) and a second module SD that is expanded in a storage area (the auxiliary storage device 151). Furthermore, the second module SD is classified into a third module MA, a fourth module SDC, and a fifth module SDS. For example, the first module SF includes the operating system, the BIOS, and the like of the image forming device 100, and the third module MA includes firmware, system software, and the like. The first module SF and the third module MA are modules that are common and identical among the target models and correspond to the basic software described above.

The third module MA, for example, is installed only once when the image forming device 100 is manufactured. The fourth module SDC is a module other than the third module MA among modules common to the target model. The fifth module SDS is a module that is unique to each model of target models. The fourth module MA is classified into a sixth module SDCC that is common and identical among the target models and a seventh module SDCS that is common and non-identical among the target models. In the example illustrated in FIG. 7, the first module SF, the third module MA, and the sixth module SDCC correspond to the first type module, the fifth module SDS corresponds to the second type module, and the seventh module SDCS corresponds to the third type module.

For example, setting files that are common to target models and are used for storing different setting details for respective models and the like may be included in the seventh module SDCS. For example, modules developed separately for respective models for reducing the difficulty of development and the like may be included in the fifth module SDS.

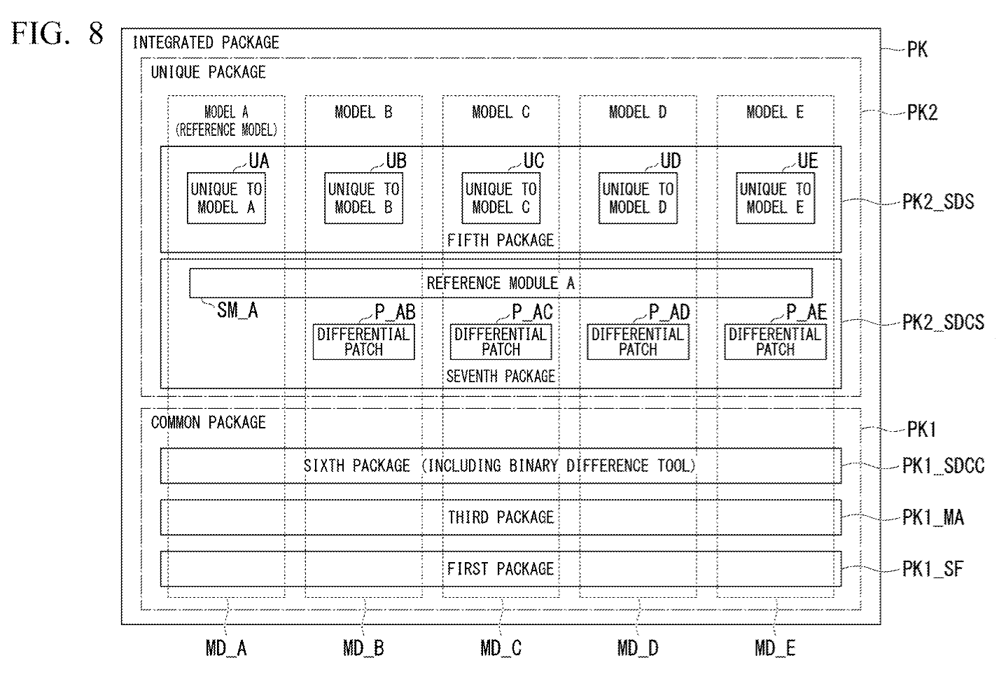

FIG. 8 illustrates a configuration example of an integrated package. FIG. 8 is an example of an integrated package generated using five models including model A, model B, model C, model D, and model E as target models. The integrated package PK illustrated in the example of FIG. 8 includes a common package PK1 in which first type modules that are common and identical among target models and a unique package PK2 in which second type modules that are unique for respective target models and third type modules that are common and non-identical among the target models are stored.

The common package PK1 includes a first package PK1_SF in which first modules SF are arranged, a third package PK1_MA in which third modules MA are arranged, and a sixth package PK1_SDCC in which sixth modules are arranged. The common package PK1 is commonly applied to all the target models.

The unique package PK2 includes a fifth package PK2_SDS in which fifth modules SDS are arranged and a seventh package PK2_SDCS that is based on the seventh module SDCS. The unique package PK2 includes a unique module for each model for all the target models. In the image forming device 100 that is an application target, unique modules corresponding to the model of the image forming device 100 among unique modules included in the unique package PK2 are installed.

The seventh package PK2_SDCS includes a module SM_A of model A, which becomes the reference among the seventh module SDCS, and differential patches P_AB, P_AC, P_AD and P_AE applied to the module SM_A. Hereinafter, the module of a model that becomes the reference is referred to as a "reference module", and a module that is common to the reference module and is non-identical in another model is referred to as a “corresponding module”. The differential patch P_AB is a differential patch that restores a corresponding module of the model B from the reference module SM_A. Similarly, the differential patches P_AC, P_AD, and P_AE are respectively differential patches that restore the corresponding modules of the models C, D, and E from the reference module SM_A. The differential patch includes differential data representing a difference of the corresponding module from the reference module and a difference application program that executes the process of restoring a corresponding module by applying the differential data to the reference module.

FIG. 8 illustrates one reference module SM_A and respective differential patches P_AB, P_AC, P_AD, and P_AE for the reference module in the seventh package PK2_SDCS. For example, the seventh package PK2_SDCS may include a set of a module of a reference model (reference module) and a differential patch of each of the other models for each module that is common in the seventh module SDCS.

In the case of the example of the integrated package PK illustrated in FIG. 8, for the model A, which is the reference model, the unique module UA of the model A, the reference module SM_A, and each module in the common package PK1 are installed from the integrated package PK in the image forming device 100 as a module group MD_A for the model A. For the model B, which is not a reference model (this also applies to the models C to E), the unique module UB of the model B, the reference module SMA, the differential patch P_AB, and each module included in the common package PK1 are installed from the integrated package PK1 in the image forming device 100 as a module group MD_B for the model B. In this case, the image forming device 100 of the model B can restore the corresponding module by applying the differential patch P_AB to the reference module SM_A.

In this embodiment, instead of including modules that are common and non-identical (common non-identical modules) among target models in the integrated package for each target model, one module (the reference module) of the reference model that is commonly used at the time of restoration and the differential patch restoring a corresponding module by applying differential data to the reference module are included in the integrated package, and thus, an overlapping part between common and non-identical modules between target models is excluded, and the data size of the integrated package can be decreased more than in a conventional case.

As illustrated in FIG. 8, the package generator 364 may include the binary difference tool used in generating differential patches in the common package PK1 (for example, the sixth package PK1_SDCC). In accordance with this, when the image forming device 100 of the target model applies an integrated package to its own device, a common module can be restored using the same binary difference tool that has been used for generating the differential patch, and thus the application of the integrated package can be suppressed from failing due to a difference in the version of the binary difference tool and the like. According to the integrated package configured in this way, the same binary difference tool can be used by the target models, and thus efforts for managing the version of the binary difference tool can be eliminated in the image forming device 100.

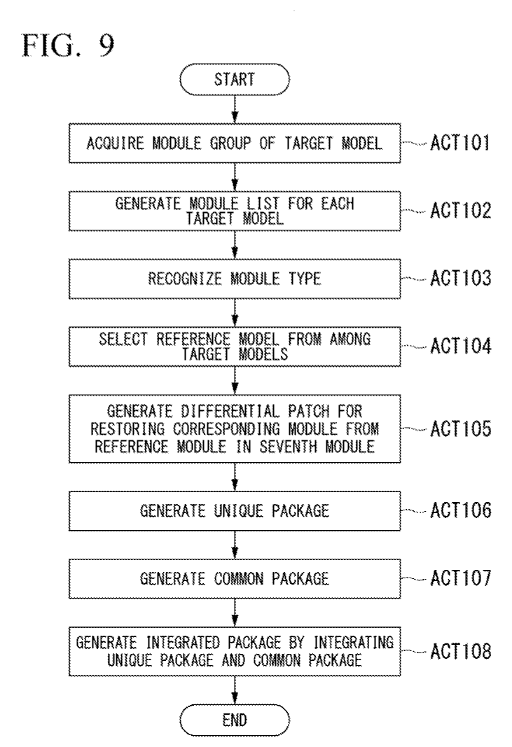

FIG. 9 illustrates an example of the flow of a process in which the administrator terminal 300 according to the embodiment generates an integrated package applied to the image forming device 100 of the target model. First, the administrator terminal 300 downloads modules developed and managed for the image forming device 100 of the target model from the development environment 400 (ACT101). The administrator terminal 300 generates a module list for each target model for the modules downloaded in ACT101 (ACT102).

In this embodiment, in the development environment 400, modules of target models are managed for each model in the same directory structure as that of the image forming device 100 that is the application destination. Since it is easy to download the modules of a target model into a download area for each model for each directory structure, it is easy to reproduce the file system for each model in a local area of the administrator terminal 300. A module list for each model can be generated by scanning the file system for each model and calculating the hash value of each module.

Subsequently, the administrator terminal 300 recognizes the module type (the first type module, the second type module, or the third type module) of the target module by comparing the module list generated in ACT102 among the target models (ACT103). For example, among the first type modules, the first module SF and the third module MA are managed separately as basic programs. For example, for the second module SD, the fifth module SDS (the second type module), the sixth module SDCC (the first type module), and the seventh module SDCS (the third type module) are recognized.

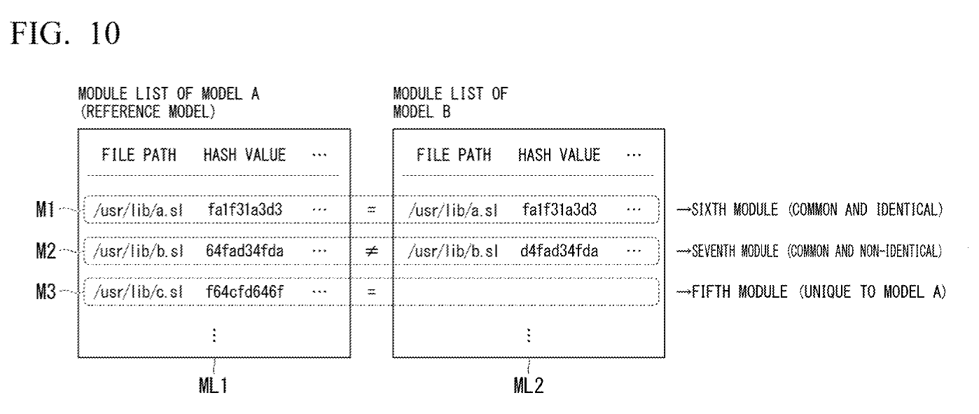

FIG. 10 illustrates the process of recognizing a module type by comparing module lists. FIG. 10 is an example of a case in which module lists are compared with each other between two models including model A and model B. In this example, a module list ML1 on the left side represents the module list of the model A, and a module list ML2 on the right side represents the module list of the model B. For example, the module list includes a full path and a hash value of each module. For example, the administrator terminal 300 can identify modules of which full paths are the same as common modules and identify modules of which hash values are the same as identical modules by comparing full paths between the models.

In the example illustrated in FIG. 10, the module M1 has a full path and a hash value that are identical between the model A and the model B. For this reason, the administrator terminal 300 can recognize the module M1 as the sixth module SDCC. The module M2 has an identical full path between the model A and the model B and has a difference between hash values thereof. For this reason, the administrator terminal 300 can recognize the module M2 as the seventh module SDCS. The module M3 is present only in the model A and is not present in the model B. For this reason, the administrator terminal 300 can recognize the module M3 as the fifth module SDS.

In the example illustrated in FIG. 10, although hash values are used as information used for judgment of the identity of modules, information other than hash values may be used for judgment of the identity of modules. For example, information other than hash values may be file sizes, dates, or the like. For example, the administrator terminal 300 may judge modules of which the file sizes and dates are identical as identical modules in place of the hash values. Basically, although there is a high possibility of identical data if the hash values are identical, in a case in which the possibility of hash values conflicting and the like are considered, the administrator terminal 300 may judge whether or not the modules are identical in accordance with coincidence of the file size and/or date in addition to coincidence of hash values.

Description is continued with reference back to FIG. 9. Subsequently, the administrator terminal 300 selects a reference model from among target models (ACT104). The reference model may be selected randomly or may be selected on the basis of an arbitrary rule. For the seventh module SDCS, the administrator terminal 300 generates a differential patch for restoring corresponding modules of each of models other than the reference model from a reference module relating to the reference model selected in ACT104 by using the binary difference tool (ACT105).

For example, in the example illustrated in FIG. 8, the administrator terminal 300 generates a differential patch P_AB by comparing the reference module SM_A with the corresponding module of the model B. Similarly, also for models C, D, and E, the administrator terminal 300 generates differential patches P_AC, P_AD, and P_AE by comparing the reference module SM_A with the corresponding module of each of the models. The administrator terminal 300 generates differential patches for sets of all the modules that are common in the seventh module.

Subsequently, the administrator terminal 300 generates a unique package PK2 on the basis of the differential patch generated in ACT105 and the reference module corresponding to this differential patch (the seventh package) and the unique module that is unique to each model (the fifth package) (ACT106) and generates a common package PK1 on the basis of the sixth module SDCC recognized in ACT103 and the binary difference tool PG3 used in ACT105 (ACT107).

Then, the administrator terminal 300 generates an integrated package PK by integrating the unique package PK2 generated in ACT106 and the common package PK1 generated in ACT107 into one (ACT108).

The common package PK1 generated by ACT107 may include the first module SF and the third module MA.

According to the module management system 1 of the embodiment described above, by executing the package program PG2 using the administrator terminal 300, module packages corresponding to target models can be generated with higher accuracy.

### Modified Example

In the embodiment described above, modules of target models are managed in advance such that they are classified into one of the first type module, the second type module, and the third type module. However, a case in which modules not corresponding to such module types are included in the target modules is also considered. For example, modules that are common to some of the target models, modules that are identical in some of the target models, modules that are identical but not common among the target models, and the like may be considered. For such modules, by separately managing the range of “common” or “identical”, the modules may be managed as one of the first to third module types. For example, for modules that are common and identical in some of target models, by managing a correspondence relation of models in which the modules are common among target models, the modules may be managed as the first type modules.

The functions of the controller 170 and/or the controller 360 according to the embodiment described above may be realized by a computer. In such a case, by recording a program used for realizing the function on a computer-readable recording medium and causing the computer system to read and execute the program recorded on this recording medium, the function may be realized. The “computer system” described here includes an OS and hardware such as peripherals. The “computer-readable recording medium” represents a portable medium such as a flexible disc, a magneto-optical disk, a ROM, or a CD-ROM or a storage device such as a hard disk built into a computer system. Furthermore, the “computer-readable recording medium” may include a medium dynamically storing the program for a short time such as a communication line of a case in which the program is transmitted through a network such as the Internet or a communication circuit line such as a telephone line and a medium storing the program for a predetermined time such as an internal volatile memory of the computer system that becomes a server or a client in such a case. The program described above may be a program used for realizing a part of the function described above or a program that can realize the function described above in combination with a program that is already recorded in the computer system.

While certain embodiments have been described, such embodiments are presented as examples but are not intended to limit the scope of the present invention. These embodiments may be performed in other various forms, and various omissions, substitutions, and changes may be performed in a range not departing from the concept of the present invention therein. These embodiments and the modifications thereof, similar to a case where these are included in the scope or the concept of the invention, are included in inventions described in the claims and equivalent ranges thereof.

What is claimed is:

1. A non-transitory storage medium having a module package stored therein, the module package comprising:
a first type module that is common to target models of image forming devices and is identical among the target models;
a second type module that is unique to the respective target models;
restoration data used for restoring a third type module that is common to the target models and is not identical among the target models for each of the target models; and
a restoration tool used for restoring the third type module on the basis of the restoration data.

2. The non-transitory storage medium according to claim 1, wherein the restoration data includes a reference module that is the third type module of a reference model that becomes a reference among the target models and differential data representing differences between the third type module of models other than the reference model among the target models and the reference module.

3. The non-transitory storage medium according to claim 2,
wherein the first type module, the reference module, and the restoration tool are stored in a first area, and
wherein the second type module and the differential data are stored in a second area different from the first area.

4. The non-transitory storage medium according to claim 1, wherein the first type module includes modules expanded into a read only memory (ROM) area of the image forming device.

5. The non-transitory storage medium according to claim 4, wherein the modules expanded into the ROM area include a basic software.

6. The non-transitory storage medium according to claim 1, wherein the first type module includes manufacturing modules that are commonly installed in the target models only once at the time of manufacturing the image forming devices of the target models among modules installed in storage areas of the image forming devices of the target models.

7. The non-transitory storage medium according to claim 6, wherein the manufacturing modules include a module that is used for building an initial root file system in the storage area and a module of system software installed in the initial root file system.

8. The non-transitory storage medium according to claim 1, wherein the first type module includes an updating module that is commonly installed in the target models at the time of system update of the image forming device of the target model.

9. A module package generating device comprising:
a classifier that classifies modules installed in target models of image forming devices into a first type module that is common to the target models of the image forming devices and are identical among the target models, a second type module that is unique to the respective target models, and a third type module that is common to the target models and are not identical among the target models;
a restoration data acquirer that acquires restoration data used for restoring the third type module of an arbitrary model among the target models on the basis of the third type module of a reference model that becomes a reference among the target models; and
a package generator that generates a module package that includes the first type module, the second type module, the restoration data, and a restoration tool used for restoring the third type module on the basis of the restoration data.

10. The module package generating device according to claim 9, wherein the restoration data acquirer generates data including a reference module that is the third type module of a reference model that becomes a reference among the target models and differential data representing differences between the third type module of models other than the reference model among the target models and the reference module as the restoration data.

11. The module package generating device according to claim 10, wherein the package generator stores the first type module, the reference module, and the restoration tool in a first area inside the module package and stores the second type module and the differential data in a second area, which is an area inside the module package, different from the first area.

12. The module package generating device according to claim 9, wherein the classifier classifies modules expanded into a read only memory (ROM) area of the image forming device as the first type module.

13. The module package generating device according to claim 12, wherein the modules expanded into the ROM area include a basic software.

14. The module package generating device according to claim 9, wherein the classifier classifies manufacturing modules that are commonly installed in the target models only once at the time of manufacturing the image forming devices of the target models among modules installed in storage areas of the image forming devices of the target models as the first type module.

15. The module package generating device according to claim 14, wherein the manufacturing modules include a module that is used for building an initial root file system in the storage area and a module of system software installed in the initial root file system.

16. The module package generating device according to claim 9, wherein the classifier classifies an updating module that is commonly installed in the target models at the time of system update of the image forming device of the target model as the first type module.

17. The module package generating device according to claim 9, wherein the classifier acquires path information representing a file name and a storage directory path for a module installed in the target model and judges commonality of the module among the target models by comparing the path information among the target models.

18. The module package generating device according to claim 17, wherein the classifier calculates hash values for common modules, of which the path information coincides, among the target models and judges commonality between the common modules by comparing the hash values between the common modules.

19. The module package generating device according to claim 18, wherein the classifier generates a module list representing the path information and the hash value for modules installed in the target model for each of the target models and judges commonality and identity of the modules by comparing the module lists between the target models.

20. A module package generating method comprising:
classifying modules installed in target models of image forming devices into a first type module that are common to the target models of image forming devices and are identical among the target models, a second type module that is unique to the respective target models, and a third type module that is common to the target models and are not identical among the target models;
acquiring restoration data used for restoring the third type module of an arbitrary model among the target models on the basis of the third type module of a reference model that becomes a reference among the target models; and
generating a module package that includes the first type module, the second type module, the restoration data, and a restoration tool used for restoring the third type module on the basis of the restoration data.
